(19) United States
(12) Patent Application Publication
(10) Pub. No.: US 2009/0299990 A1
(43) Pub. Date: Dec. 3, 2009

(54) METHOD, APPARATUS AND COMPUTER PROGRAM PRODUCT FOR PROVIDING CORRELATIONS BETWEEN INFORMATION FROM HETEROGENOUS SOURCES

(76) Inventors: Vidya Setlur, Cupertino, CA (US); Agathe Battestini, Helsinki (FI)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/129,901

(22) Filed: May 30, 2008

(51) Int. Cl. G06F 17/30

(52) U.S. Cl. 707/5; 707/E17.009

(57) ABSTRACT

An apparatus for providing correlations between information from heterogeneous sources may include a processor. The processor may be configured to analyze at least two different datasets in which each dataset includes entities with respective attributes corresponding to each of the entities, determine a set of correlations between entities in which at least one correlation determined includes a correlation between entities in different datasets, and filter the set of correlations to produce a focused set of correlations based on selecting correlations among the set of correlations that correspond to selection criteria for inclusion in the focused set of correlations. The set of correlations may be determined based at least in part on the respective attributes corresponding to each of the entities.

### TECHNOLOGICAL FIELD

Embodiments of the present invention relate generally to content management and display technology and, more particularly, relate to a method, apparatus and computer program product for providing correlations between information from heterogeneous sources.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users by expanding the capabilities of mobile electronic devices. As mobile electronic device capabilities expand, a corresponding increase in the storage capacity of such devices has allowed users to store very large amounts of content on the devices. Given that the devices will tend to increase in their capacity to create content, store content and/or receive content relatively quickly upon request, and given also that mobile electronic devices such as mobile phones often face limitations in display size, text input speed, and physical embodiments of user interfaces (UI), challenges are created in content management. Specifically, an imbalance between the development of capabilities related to storing and/or accessing content and the development of physical UI capabilities may be perceived.

An example of the imbalance described above may be realized in the context of content management and/or selection. In this regard, for example, if a user has a very large amount of content stored in electronic form, it may be difficult to sort through the content in its entirety either to search for content to render or merely to browse the content. This is often the case because content is often displayed in a one dimensional list format. As such, only a finite number of content items may fit in the viewing screen at any given time. Scrolling through content may reveal other content items, but at the cost of hiding previously displayed content items.

In order to improve content management capabilities, metadata or other tags may be automatically or manually applied to content items in order to describe or in some way identify a content item as being relevant to a particular subject. As such, each content item may include one or more metadata tags that may provide a corresponding one or more relevancies with which the corresponding content item may be associated. Thus, for some content, such as, for example, a gallery of pictures, a grid or list of content items may be displayed based on the metadata. However, even when a gallery of content items is displayed, it is common for the contents of the gallery or the list to be arranged based on a single criteria (or a single metadata tag) such as date, location, individual creating or in the content item, genre, album, artist, and so on. Furthermore, arrangements of data or content are typically limited to an arrangement of content associated with a particular application. For example, a gallery may include a variety of pictures that may be related by some criteria or a media player may include a plurality of video or audio files that may be related or organized on the basis of some criteria. Similarly, a word processing application may include multiple related text based documents or a browser may include multiple related links. As such, current technologies for content management typically do not provide users with the ability to review a heterogeneous mix of content (e.g., content across various classes of content) via a single and efficient mechanism. Thus, in some instances, only a minimal or at least partial portion of a collection of content items may be browsed, played or utilized without being able to easily access related content from other classes of content.

Thus, it may be advantageous to provide an improved method of organizing and/or presenting content items, which may provide improved content management for operations such as searching, browsing, playing, editing and/or organizing content.

### BRIEF SUMMARY

A method, apparatus and computer program product are therefore provided to enable providing correlations between information from heterogeneous sources. In particular, a method, apparatus and computer program product are provided that may enable the presentation of a visualized mashup of information associated with correlations made between objects or entities among different datasets.

In one exemplary embodiment, a method of providing correlations between information from heterogeneous sources is provided. The method may include analyzing at least two different datasets in which each dataset includes entities with respective attributes corresponding to each of the entities and determining a set of correlations between entities in which at least one correlation determined includes a correlation between entities in different datasets. The set of correlations may be determined based at least in part on the respective attributes corresponding to each of the entities. The method may further include filtering the set of correlations to produce a focused set of correlations based on selecting correlations among the set of correlations that correspond to selection criteria for inclusion in the focused set of correlations.

In another exemplary embodiment, a computer program product for providing correlations between information from heterogeneous sources is provided. The computer program product includes at least one computer-readable storage medium having computer-executable program code portions stored therein. The computer-executable program code portions include first, second and third program code portions. The first program code portion is for analyzing at least two different datasets in which each dataset includes entities with respective attributes corresponding to each of the entities. The second program code portion is for determining a set of correlations between entities in which at least one correlation determined includes a correlation between entities in different datasets. The set of correlations may be determined based at least in part on the respective attributes corresponding to each of the entities. The third executable portion is for filtering the set of correlations to produce a focused set of correlations based on selecting correlations among the set of correlations that correspond to selection criteria for inclusion in the focused set of correlations.

In another exemplary embodiment, an apparatus for providing correlations between information from heterogeneous sources is provided. The apparatus may include a processor. The processor may be configured to analyze at least two different datasets in which each dataset includes entities with respective attributes corresponding to each of the entities, determine a set of correlations between entities in which at least one correlation determined includes a correlation between entities in different datasets, and filter the set of correlations to produce a focused set of correlations based on selecting correlations among the set of correlations that correspond to selection criteria for inclusion in the focused set of correlations. The set of correlations may be determined based at least in part on the respective attributes corresponding to each of the entities.

In another exemplary embodiment, an apparatus for providing correlations between information from heterogeneous sources is provided. The apparatus includes means for analyzing at least two different datasets in which each dataset includes entities with respective attributes corresponding to each of the entities and means for determining a set of correlations between entities in which at least one correlation determined includes a correlation between entities in different datasets. The set of correlations may be determined based at least in part on the respective attributes corresponding to each of the entities. The apparatus may further include means for filtering the set of correlations to produce a focused set of correlations based on selecting correlations among the set of correlations that correspond to selection criteria for inclusion in the focused set of correlations.

Embodiments of the invention may provide a method, apparatus and computer program product for employment, for example, in mobile environments. As a result, for example, mobile terminal users may enjoy an improved capability for organizing and/or accessing content.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 is a schematic block diagram of an apparatus for providing correlations between information from heterogeneous sources according to an exemplary embodiment of the present invention;

FIG. 4A illustrates an example of correlations associated with a first dataset in accordance with an exemplary embodiment of the present invention;

FIG. 4B illustrates an example of correlations associated with a second dataset in accordance with an exemplary embodiment of the present invention;

FIG. 4C illustrates an example of correlations associated with a third dataset in accordance with an exemplary embodiment of the present invention;

FIG. 5 illustrates an example of correlations associated with a composite data graph in accordance with an exemplary embodiment of the present invention;

FIG. 6 illustrates an example of link or correlation determination by a correlation miner according to an exemplary embodiment of the present invention;

FIG. 7 illustrates another example of link or correlation determination by a correlation miner according to an exemplary embodiment of the present invention;

FIG. 8 illustrates yet another example of link or correlation determination by a correlation miner according to an exemplary embodiment of the present invention;

FIG. 9 shows an example of a mashup that combines personal information with map information according to an exemplary embodiment of the present invention;

FIG. 10 illustrates an a mashup generated in the context of an enterprise phonebook application according to an exemplary embodiment of the present invention;

FIG. 11 shows another example of a mashup of images associated with contacts that may be in communication via a mobile communication service according to an exemplary embodiment of the present invention;

FIG. 12 shows an example of a mashup that combines personal information with map information according to an exemplary embodiment of the present invention; and

FIG. 13 is a flowchart according to an exemplary method for providing correlations between information from heterogeneous sources according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

Social networking and sharing of personal information are recent trends of PC computing that are permeating into the mobile sector. Thus, given the ubiquitous nature of mobile devices and their ability to keep users connected with other users and services (e.g., via the Internet), the use of mobile devices as another dimension to social computing may seem like a logical step. As indicated above, mobile devices are typically used to create and share content. As such devices become more and more sophisticated, the kinds of content that can be exchanged between the mobile device and Internet based social networking sites, will only increase. In anticipation of this trend, Web-based social networking sites like MySpace are moving into the mobile realm to increase their reach and popularity.

Additionally and in parallel, improved mechanisms for sharing and viewing information from various services are in development. According to an exemplary embodiment of the present invention, one such mechanism for providing a user with an ability to view diverse sources of data in an integrated manner may be called a visual mashup. A visual mashup may provide the user with an ability to view many different types or classes of data or objects, which may each belong to diverse sets of data or datasets (e.g., heterogeneous sources). Many of these diverse sets of data have rich semantics in communication behavior, along with metadata that provides a greater sense of context to the user's intention or task. As used herein, the term dataset should be understood to correspond to one or more, such as a group or plurality of, data, objects, information, content items, or the like that is associated with a particular source (e.g., a webpage, address, storage location, file, document, social network, application, or the like). Embodiments of the present invention may leverage context along various dimensions that could be spatial, temporal, or topical in nature, from different communities that a person may be a part of, including social communities or the mobile space.

Embodiments of the present invention may thereafter enable visually creating mashups including the information (e.g., data or objects) from the various sources or data sets in a variety of different visual presentation styles. In this regard, for example, multiple mini-displays may be provided for each data source on the same container page or a single display that may combine the multiple data sources. As such, embodiments of the present invention may provide a greater sense of communal information interchange among information from various social communities by enabling the serendipitous discovery of relationships between objects or content of different classes and the presentation of information based on such relationships. As an example, a picture taken on a cell phone (e.g., mobile data) and a popular restaurant in a particular location corresponding to the location at which the picture was taken may enable the correlation of the two objects (e.g., the picture and information about the restaurant). The two correlated objects, in some cases along with other correlated information of the same or different classes, may then be presented in a mashup for the user to view.

As such, embodiments of the present invention may provide tools and mechanisms for automatically determining implicitly unapparent correlations among data collected from different social communities or object classes including data collected by a mobile terminal. By thereafter presenting such correlations in an automatically created visual mashup, the user may be assisted in serendipitous discovery of correlations that can be either useful, immersive, entertaining or a combination of the above. Using serendipity to improve context-awareness and relevancy may be an interesting topic spanning various types of social communities such as the mobile device (e.g. contacts), Internet services (e.g. Flickr, Facebook, LinkedIn), and enterprise services (e.g. a corporate phonebook directory). By leveraging information from all these heterogeneous sources and others, it may be possible to create a new way of correlating interesting connections between different types of information. These correlations in turn provide useful insight into new visual representations and mashups of this data.

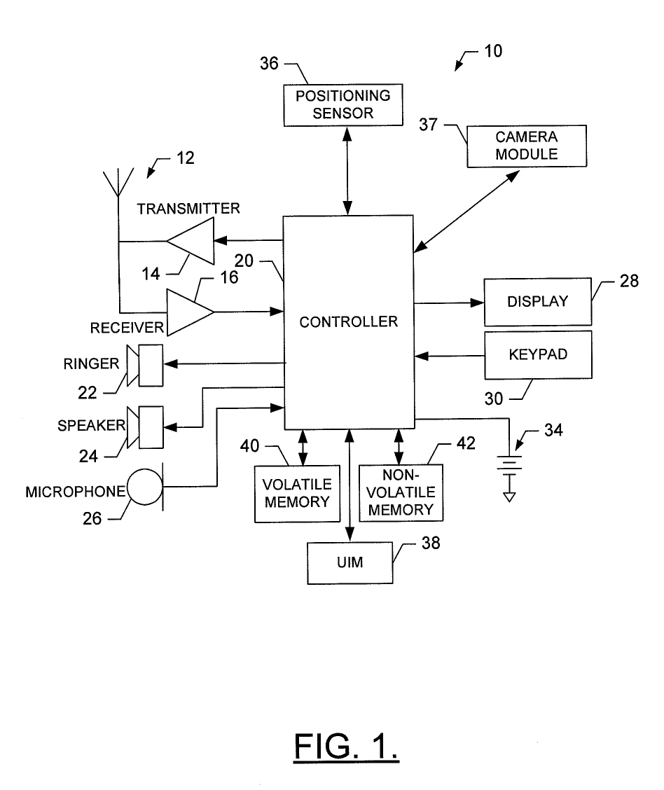

FIG. 1, one exemplary embodiment of the invention, illustrates a block diagram of a mobile terminal 10 that may benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While several embodiments of the mobile terminal 10 are illustrated and will be hereinafter described for purposes of example, other types of mobile terminals, such as portable digital assistants (PDAs), pagers, mobile televisions, gaming devices, all types of computers, cameras, video recorders, audio/video player, radio, GPS devices, tablets, internet capable devices, or any combination of the aforementioned, and other types of communications systems, can readily employ embodiments of the present invention.

In addition, while several embodiments of the method of the present invention are performed or used by a mobile terminal 10, the method may be employed by other than a mobile terminal. Moreover, the system and method of embodiments of the present invention will be primarily described in conjunction with mobile communications applications. It should be understood, however, that the system and method of embodiments of the present invention can be utilized in conjunction with a variety of other applications, both in the mobile communications industries and outside of the mobile communications industries.

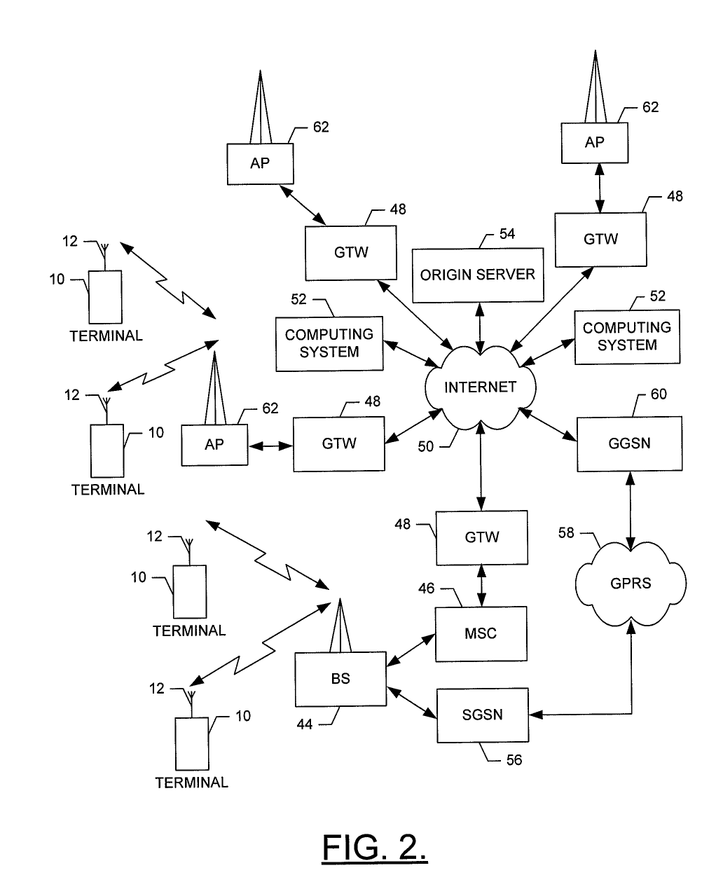

The mobile terminal 10 includes an antenna 12 (or multiple antennas) in operable communication with a transmitter 14 and a receiver 16. The mobile terminal 10 further includes an apparatus, such as a controller 20 or other processing element, that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA)), with 3.9G wireless communication protocol such as E-UTRAN (Evolved UMTS Terrestrial Radio Access Network), with fourth-generation (4G) wireless communication protocols or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks described below in connection with FIG. 2.

It is understood that the apparatus such as the controller 20 includes circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other hard and soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output. In addition, the mobile terminal 10 may include a positioning sensor 36. The positioning sensor 36 may include, for example, a global positioning system (GPS) sensor, an assisted global positioning system (Assisted-GPS) sensor, etc. However, in one exemplary embodiment, the positioning sensor 36 includes a pedometer or inertial sensor. In this regard, the positioning sensor 36 is capable of determining a location of the mobile terminal 10, such as, for example, longitudinal and latitudinal directions of the mobile terminal 10, or a position relative to a reference point such as a destination or start point. Information from the positioning sensor 36 may then be communicated to a memory of the mobile terminal 10 or to another memory device to be stored as a position history or location information.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an electrically erasable programmable read only memory (EEPROM), flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10. Furthermore, the memories may store instructions for determining cell id information. Specifically, the memories may store an application program for execution by the controller 20, which determines an identity of the current cell, i.e., cell id identity or cell id information, with which the mobile terminal 10 is in communication. In conjunction with the positioning sensor 36, the cell id information may be used to more accurately determine a location of the mobile terminal 10.

In an exemplary embodiment, the mobile terminal 10 includes a media capturing module, such as a camera, video and/or audio module, in communication with the controller 20. The media capturing module may be any means for capturing an image, video and/or audio for storage, display or transmission. For example, in an exemplary embodiment in which the media capturing module is a camera module 37, the camera module 37 may include a digital camera capable of forming a digital image file from a captured image, or a video file from a series of captured image frames with or without accompanying audio data. As such, the camera module 37 includes all hardware, such as a lens or other optical device, and software necessary for creating a digital image, video or audio file from captured image/audio data. Alternatively, the camera module 37 may include only the hardware needed to capture an image, while a memory device of the mobile terminal 10 stores instructions for execution by the controller 20 in the form of software necessary to create a digital image file from a captured image. In an exemplary embodiment, the camera module 37 may further include a processing element such as a co-processor which assists the controller 20 in processing image data and an encoder and/or decoder for compressing and/or decompressing image data. The encoder and/or decoder may encode and/or decode according to, for example, a joint photographic experts group (JPEG) standard or other format.

FIG. 2 is a schematic block diagram of a wireless communications system according to an exemplary embodiment of the present invention. Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a gateway device (GTW) 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a serving GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a gateway GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP) and/or the like, to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) may be capable of supporting communication in accordance with any one or more of a number of first-generation (1G), second-generation (2G), 2.5G, third-generation (3G), 3.9G, fourth-generation (4G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as a UMTS network employing WCDMA radio access technology. Some narrow-band analog mobile phone service (NAMPS), as well as total access communication system (TACS), network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), infrared (IrDA) or any of a number of different wireless networking techniques, including wireless LAN (WLAN) techniques such as IEEE 802.11 (e.g., 802.11a, 802.11b, 802.11g, 802.11 n, etc.), world interoperability for microwave access (WiMAX) techniques such as IEEE 802.16, and/or wireless Personal Area Network (WPAN) techniques such as IEEE 802.15, BlueTooth (BT), ultra wideband (UWB) and/or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX, UWB techniques and/or the like. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including universal serial bus (USB), LAN, WLAN, WiMAX, UWB techniques and/or the like.

In an exemplary embodiment, content or data may be communicated over the system of FIG. 2 between a mobile terminal, which may be similar to the mobile terminal 10 of FIG. 1, and a network device of the system of FIG. 2 in order to, for example, execute applications or establish communication (for example, for purposes of content, data or information sharing) between the mobile terminal 10 and other mobile terminals or network devices. As such, it should be understood that the system of FIG. 2 need not be employed for communication between mobile terminals or between a network device and the mobile terminal, but rather FIG. 2 is merely provided for purposes of example. Furthermore, it should be understood that embodiments of the present invention may be resident on a communication device such as the mobile terminal 10, and/or may be resident on a mobile telephone, mobile computer, gaming device, camera, server, network device, computer or other device, with or without any communication via the system of FIG. 2.

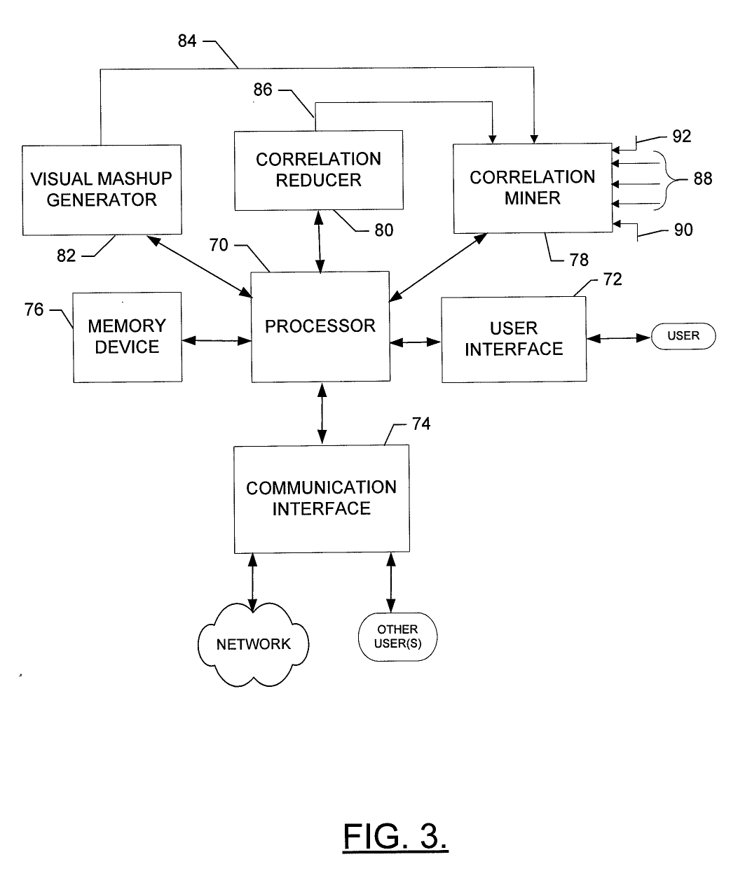

An exemplary embodiment of the invention will now be described with reference to FIG. 3, in which certain elements of an apparatus for providing correlations between information from heterogeneous sources are displayed. The apparatus of FIG. 3 may be employed, for example, on the mobile terminal 10 of FIG. 1. However, it should be noted that the system of FIG. 3, may also be employed on a variety of other devices, both mobile and fixed, and therefore, the present invention should not be limited to application on devices such as the mobile terminal 10 of FIG. 1. Alternatively, embodiments may be employed on a combination of devices including, for example, those listed above. Accordingly, embodiments of the present invention may be embodied wholly at a single device (e.g., the mobile terminal 10) or by devices in a client/server relationship. Furthermore, it should be noted that the devices or elements described below may not be mandatory and thus some may be omitted in certain embodiments.

Referring now to FIG. 3, an apparatus for providing correlations between information from heterogeneous sources is provided. The apparatus may include or otherwise be in communication with a processor 70, a user interface 72, a communication interface 74 and a memory device 76. The memory device 76 may include, for example, volatile and/or non-volatile memory. The memory device 76 may be configured to store information, data, applications, instructions or the like for enabling the apparatus to carry out various functions in accordance with exemplary embodiments of the present invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information and/or media content.

The processor 70 may be embodied in a number of different ways. For example, the processor 70 may be embodied as various processing means such as a processing element, a coprocessor, a controller or various other processing devices including integrated circuits such as, for example, an ASIC (application specific integrated circuit) or an FPGA (field programmable gate array). In an exemplary embodiment, the processor 70 may be configured to execute instructions stored in the memory device 76 or otherwise accessible to the processor 70. Meanwhile, the communication interface 74 may be embodied as any device or means embodied in either hardware, software, or a combination of hardware and software that is configured to receive and/or transmit data from/to a network and/or any other device or module in communication with the apparatus. In this regard, the communication interface 74 may include, for example, an antenna and supporting hardware and/or software for enabling communications with a wireless communication network. In fixed environments, the communication interface 74 may alternatively or also support wired communication. As such, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a touch screen display, a conventional display, a microphone, a speaker, or other input/output mechanisms. In an exemplary embodiment in which the apparatus is embodied as a server or some other network devices, the user interface 72 may be limited, or eliminated. However, in an embodiment in which the apparatus is embodied as a mobile terminal (e.g., the mobile terminal 10), the user interface 72 may include, among other devices or elements, any or all of the speaker 24, the ringer 22, the microphone 26, the display 28, and the keyboard 30. In some embodiments in which the apparatus is embodied as a server or other network device, the user interface 72 may be limited or eliminated completely.

In an exemplary embodiment, the processor 70 may be embodied as, include or otherwise control a correlation miner 78, a correlation reducer 80 and/or a visual mashup generator 82. The correlation miner 78, the correlation reducer 80 and the visual mashup generator 82 may each be any means such as a device or circuitry embodied in hardware, software or a combination of hardware and software that is configured to perform the corresponding functions of the correlation miner 78, the correlation reducer 80 and the visual mashup generator 82, respectively, as described below. In some embodiments, the correlation miner 78 may be configured to receive pruning constraints 84 or other feedback from the data reducer 80 and/or receive interaction provided via mashups generated by the visual mashup generator 82 as shown by interaction 86 in FIG. 3.

In this regard, the correlation miner 78 may be configured to enable the apparatus to determine whether correlations exist between various entities or objects within the same and/or different datasets. In an exemplary embodiment, correlations between various objects or entities may be made on the basis of shared attributes among the objects or entities. The attributes may be, for example, information descriptive of a characteristic of the object, context information associated with the object, information descriptive of relationships associated with the object, etc. In some embodiments, the correlation miner 78 may be embodied as an algorithm used in analyzing data from various sources accessible to the processor 70 (e.g., from the memory device 76 or via the communication interface 74) for correlations between different objects or entities. In an exemplary embodiment, the correlation miner 78 may receive input data sets 88, each of which may correspond to a respective data graph as described below. The correlation miner 78 may also receive user parameters 90 and/or system parameters 92 comprising rules, guidance or instructions relating to the establishment of correlations. As such, for example, the user parameters 90 may be entered via the user interface 72 or an interface of a remote device to indicate conditions under which the correlation miner 78 should operate and/or particular instructions or rules regarding stimuli to which the correlation miner can respond and/or regarding responses to be provided to the stimuli. Similarly, the system parameters 92 may provide such rules as provided by a network operator or other entity related to the system or network in which the apparatus operates.

In an exemplary embodiment, the correlations may be made between objects or entities within the same or different data sets based on attributes associated with each of the objects or entities. Additionally, or alternatively, the correlations may be made based on relationships between the entities or between the attributes. In this regard, for example, the correlation miner 78 may utilize a variety of heterogeneous data graphs (e.g., social graphs or content related graphs describing entities or objects associated with a particular application or data set and the relationships therebetween) to establish or identify correlations between objects or entities within the same or different data graphs that may not be obvious to a user when the different data graphs are viewed in isolation in order to create a dataset (e.g., a composite dataset) that includes indications of the correlations established or identified. As such, for example, data or content associated with a gallery of pictures stored on a mobile phone may be considered along with data or content associated with an application or web service such as a social network like Flickr or Facebook to identify correlations between entities or objects associated with the respective objects or entities therein.

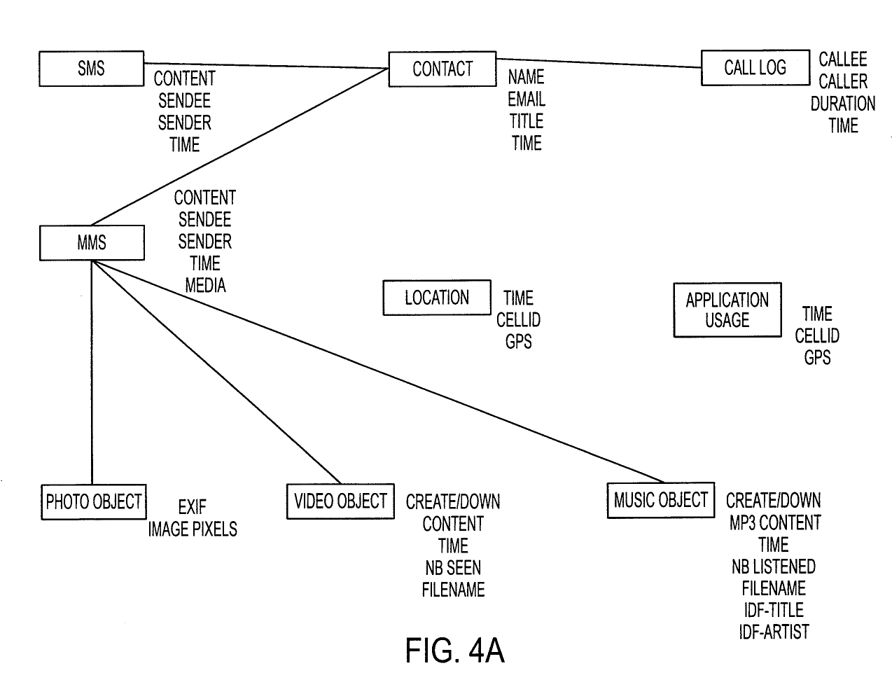

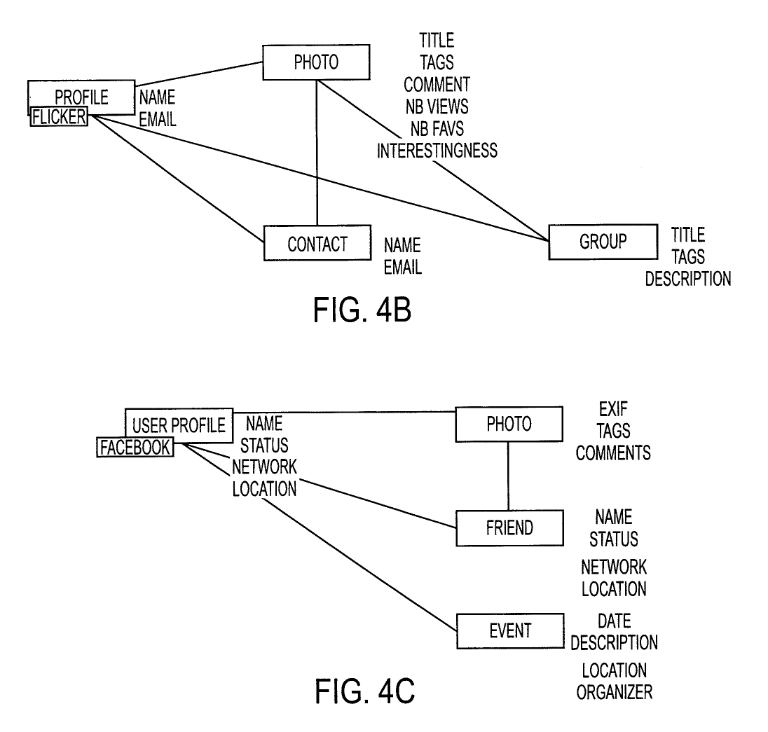

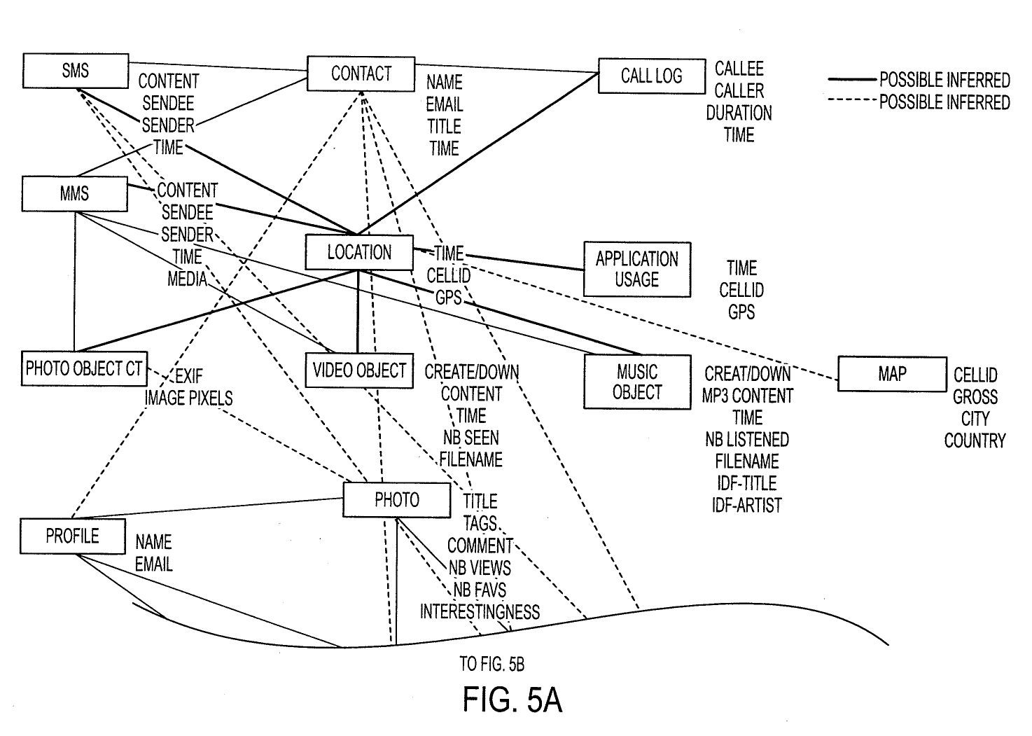

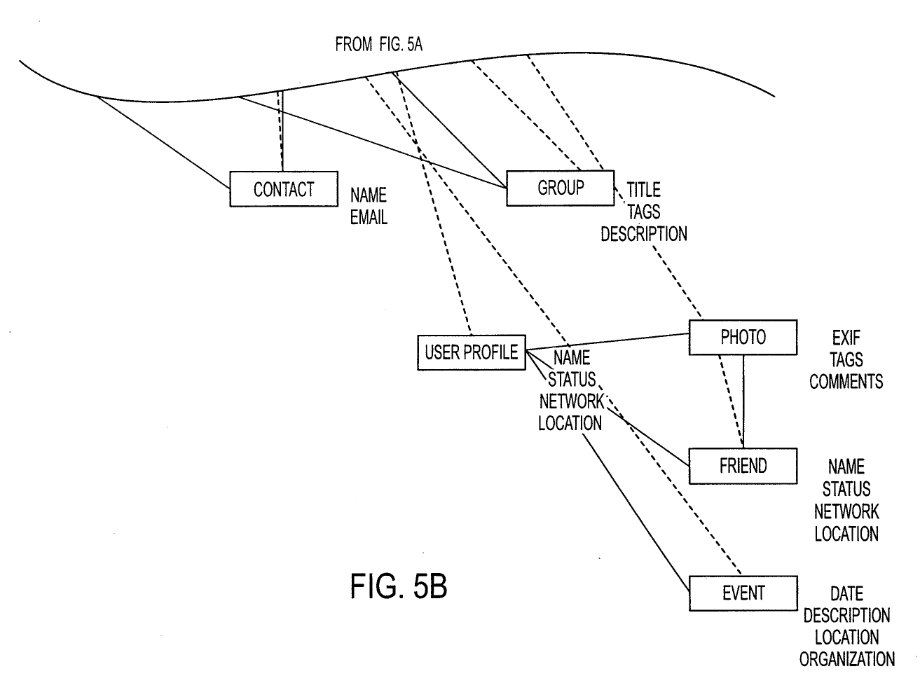

The correlation miner 78 may either utilize existing graphic representations or data graphs of social or mobile datasets or other datasets or generate such data graphs for use in correlation mining as described herein. FIGS. 4A, 4B and 4C illustrate examples of three separate datasets (e.g., a first dataset in FIG. 4A, a second dataset in FIG. 4B and a third dataset in FIG. 4C) that may be combined into a composite dataset, as shown in FIG. 5, with correlations identified by the correlation miner 78 added to form a composite data graph. The datasets may be considered to be heterogeneous as they originate from different sources and could possibly have different inherent structures or, in some cases, may even be unstructured. Similar concepts (e.g. a user profile or user account) can be represented differently in each dataset. For example, a name or list of attributes of an object can be different.

A node (e.g., a vertex) of a correlated data graph may represent a class of an object or entity (e.g. a contact, a user profile, an image), and the object's or entity's attributes (e.g. the attributes of a contact object are first name, last name, phone number, address, etc). An edge between any two nodes may represent a possible correlation or relationship between the two classes of objects (e.g. link between an SMS and a contact object). The relationship need not be explicit, such as by each entity or object including shared metadata related to a particular topic. Instead, the relationship could be inferred based on data properties (e.g., attributes or relationships between attributes) associated with the entities. In some embodiments, the relationships could be between entities based on attributes, but the relationships could also or alternatively be between entities based on relationships between the entities. Thus, for example, an SMS may be transmitted between two contacts in which the content of the SMS includes information about a particular event or third party. The content of the SMS may be parsed and the name of the third party or event may be recognized as a basis for correlating the SMS with other entities associated with the particular event or third party. However, such correlations are not merely limited to data. In this regard, for example, media such as photographs with a particular feature recognized therein may be correlated as well. Thus, although correlations may be made on the basis of explicit relationships that may be evident via shared metadata, the correlations may also be made on the basis of inferred relationships determinable based on attributes associated with each entity or based on the relationships between the entities themselves. Furthermore, the relationships may be within one dataset or across multiple datasets.

Given an input set of data graphs (e.g., FIGS. 4A, 4B and 4C), the correlation miner 78 may be configured to perform any or all of tasks such as augmentation of a set of nodes, augmentation of a set of attributes of each node, and establishing new links (correlations) between the nodes. Each box shown in FIGS. 4A, 4B and 4C may represent an object or entity associated with a respective dataset. For example, data objects or entities associated with the first dataset, which may be a dataset associated with a mobile terminal or service platform associated with a mobile communication service provider, may include SMS, contact, MMS, call log, application usage, location, photo, video, music and/or other categories. Meanwhile, a social networking application (e.g., Facebook) associated with the second dataset may include user profile, photo, friend, event, and/or other categories as the objects therein. Another social networking application associated with the third dataset (e.g., Flickr) may include user profile, photo, contact, group, and/or other categories as objects therein. Still other applications, such as for example, a map application with collections of maps and geo-location attributes associated with each map may also or alternatively be included as a separate dataset.

In an exemplary embodiment, the first dataset may be a dataset comprising various content items or application related data stored on or in association with a particular device (e.g., stored within the memory device 76 of the mobile terminal 10). Meanwhile, the second and third datasets may be datasets comprising content items stored at a location associated with a respective application corresponding to each respective dataset either at the particular device or at a location accessible by the particular device. As such, for example, the second dataset could be data associated with Flickr while the third dataset may be associated with Facebook as indicated above. Attributes are shown in FIGS. 4A, 4B and 4C in association with each respective entity in a list format. Meanwhile, lines between each entity are indicative of relationships between entities (e.g., based on the attributes) or indicative of relationships between attributes themselves. The relationships shown are not all inclusive, but merely exemplary.

An output of the correlation miner 78 may be another graph (e.g., as shown in FIG. 5) that may include correlated links in the heterogeneous data graphs. The nodes and the edges of the output or composite graph of FIG. 5 may be identical to those of the input graphs of FIGS. 4A, 4B and 4C except that the composite graph may include additional modified or derived links from one or more data mining algorithms used in the data correlation process employed by the correlation miner 78. The modified or derived links or correlations may include, for example, additional inferred links associated with location within a same dataset (e.g., the first dataset) or additional links associated with inferred correlations among entities across multiple datasets (e.g., as shown by the dashed lines connecting various entities in different datasets).

Various types of correlations may be performed. In this regard, direct correlations may be made within a dataset. For example, links may be expressed in relational databases (1 to 1, 1 to many, many to many) such as, the attribute ‘sender’ of the SMS referring to an object ‘contact’. As another example, inferred correlation may be accomplished within a dataset such as in the case of a mobile device on which the location is sampled (e.g. every 10 minutes) at a predetermined interval or in response to predetermined events. As such, it may be possible to infer the location from which an SMS was sent (e.g. by selecting the location the nearest in time to the time of receipt or transmission). As yet another example, direct correlation may be made across datasets such as in a case where a mobile phone contact could be linked to a Facebook contact by matching a unique identification such as an email address associated with each contact. Another example may include inferring correlation across datasets such as when a mobile phone contact may be linked to a Facebook contact by best matching a non-unique identification such as a name associated with each contact.

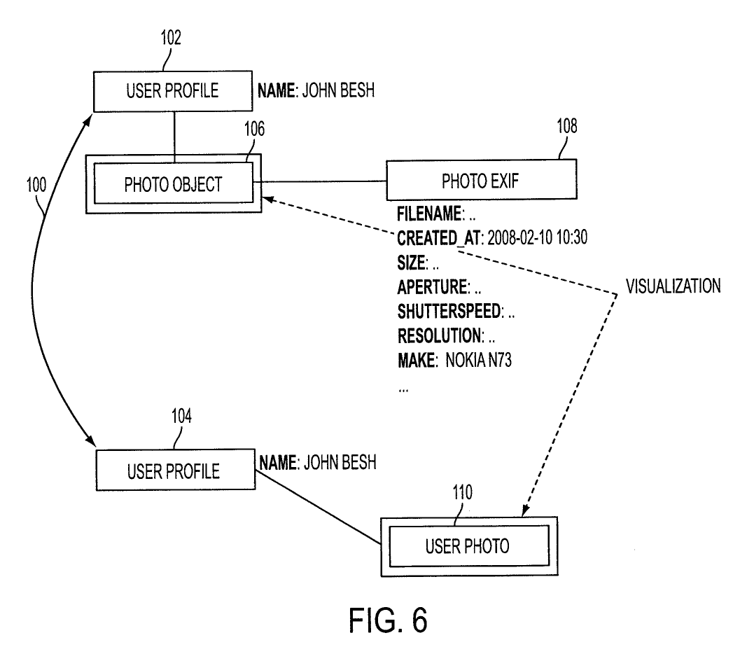

A general description of the identification or creation of a new link between nodes may include, for example, the computation of a distance function between the attributes of different nodes and the creation of a link between the nodes that minimizes the distance function. The distance function selected may depend on the type or class of attribute (e.g. numerical, text, etc.) associated with the entity or object. FIGS. 6, 7 and 8 show further examples of data correlations between various entities in data graphs.

FIG. 6 illustrates a correlation between a photo object stored in a device (or at a location associated with a first service for storing data for the device) and a user profile photo for a second service (e.g., an online service) such as, for example, Facebook. As shown in FIG. 6, a link 100 or correlation may be established between a user profile 102 of the first service and a user profile 104 of the second service. As an example, the link 100 may be established (e.g., by the correlation miner 78) on the basis of a correlation of the names associated with each of the user profiles 102, 104. The user profile 102 of the first service may be associated with a photo object 106 that may have corresponding photo EXIF (exchangeable image file) data 108 associated therewith. The user profile 104 of the second service may also have a user photo 110 associated therewith. In an exemplary embodiment, not only could the link 100 be established based on the name associated with each user profile 102, 104, but the link 100 could be established based on the contents of each photo (e.g., via image recognition) or based on descriptive data or metadata associated with each of the user profiles 102, 104 or the user photo 110 and the photo object 106. In some cases, the visual mashup generator 82 may be utilized to visualize the user photo 110 and the photo object 106 (or other information associated with the user profiles 102, 104) on a display in a mashup as described in greater detail below.

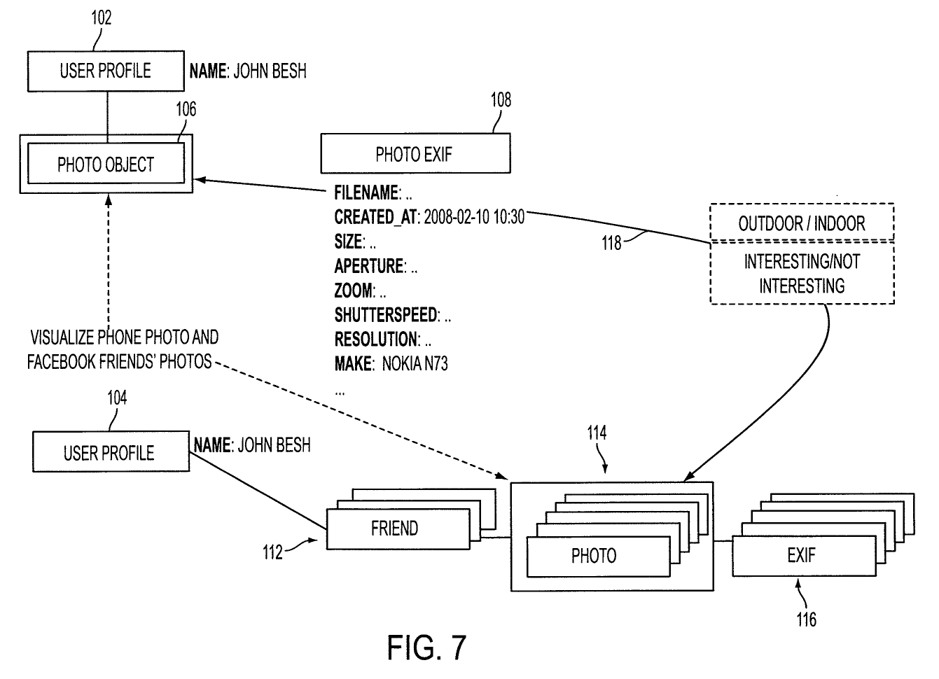

FIG. 7 illustrates another example of link or correlation determination by the correlation miner 78 according to an exemplary embodiment. In this regard, as shown in FIG. 7, various friends 112 associated with the user profile 104 of the second service may have posted corresponding photos 114 that may be similar to the photo object 106. As indicated above, a correlation or link 118 may be made between objects based on a user profile name or other data. However, in some cases, new attributes can be derived from existing objects and attributes. For example, EXIF or metadata attributes may be used to categorize photos (e.g., as indoor or outdoor) and the categorization may be run for photos in different datasets to establish links based on the new attributes. In an exemplary embodiment, EXIF data 116 corresponding to each of the photos 114 may be indicative of respective categorizations such as, for example, indoor/outdoor or interesting/not interesting, and a correlation or link 118 may be made on the basis of the respective descriptive data of the photos 114 and the photo object 106. As indicated above, the visual mashup generator 82 may be utilized to visualize the photos 114 and the photo object 106 in a mashup as described in greater detail below.

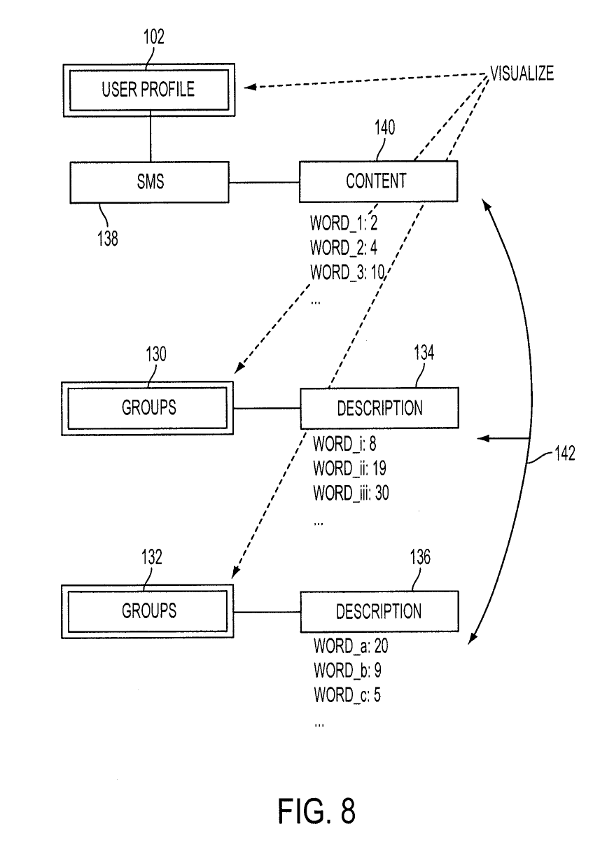

FIG. 8 illustrates yet another example of link or correlation determination by the correlation miner 78 according to an exemplary embodiment. In this regard, as shown in FIG. 8, the first dataset (e.g., a mobile device related dataset), the second dataset (e.g., Flickr data) and the third dataset (e.g., Facebook data) may be represented. A social group 130 associated with the second dataset and a social group 132 associated with the third dataset may each have associated attributes (e.g., messages, content or other descriptions 134 and 136, respectively, of topics discussed in the respective groups) that may be determined, for example, by text analysis. In this regard, text analysis may determine words used, or frequently used words or word groupings, associated with each group. Similarly, text analysis may be performed with respect to SMS data 138 such that the content 140 thereof may be analyzed for word usage and the frequency associated with such usage. Based on the text analysis, for example, in relation to topic identification, a link 142 may be established between the user profile 102 (an example of an object or entity) and the social groups 130 and 132 (examples of other objects or entities). As indicated above, an initial link may be generated based on other attributes and the link 142 may thereafter be established based on text analysis of content as described above. In an exemplary embodiment, the visual mashup generator 82 may be utilized to visualize the user and matching groups in a mashup as described in greater detail below. Of note, there need not be an exact match between the words analyzed in the text analysis. Rather, synonyms, antonyms, dictionary entries, thesaurus information, phrasal relationships, word groupings and other relationships may be employed for inferring correlation between respective text entries.

Once a set of correlations (e.g., a group or plurality of relationships between objects, data, information, etc.) has been determined by adding correlations determined by the correlation miner 78 to form a composite data graph as shown in FIG. 5, embodiments of the present invention may employ a reduction or focusing operation with respect to the set of correlations in order to provide a focused set of correlations based on selection criteria. Thus, for example, once a tree of interconnected (e.g., via established correlations or links) nodes has been established that includes inferred links determined by the correlation miner 78 (and possibly previously established links within each respective dataset as well), the tree may be pruned on the basis of certain criteria in order to provide a smaller or more focused tree that may be used to visualize information associated with the objects or entities in the focused tree in a useful or entertaining way (e.g., via the visual mashup generator 82). The correlation reducer 80 may act as a data graph pruner to perform data graph pruning to reduce the set of correlations to a smaller focused set of correlations. In this regard, as indicated above, the correlations shown in FIG. 5 may not be all inclusive. As such, for example, those correlations that are shown may be considered to be a set of correlations while perhaps only the correlations shown in dashed lines may be considered to be a focused set of correlations.

The correlation reducer 80 may be configured to reduce the set of nodes in a composite data graph, or reduce the set of links between the nodes. In other words, the correlation reducer 80 may be configured to reduce the set of correlations in the composite data graph to form a focused or reduced set of correlations. In an exemplary embodiment, the correlation reducer 80 may perform the focusing by using selection criteria to select only those correlations that meet the selection criteria or to prune or eliminate correlations that do not meet the selection criteria. In an exemplary embodiment, the selection criteria may be provided by user input (e.g., via the user interface 72). In this regard, for example, a user query providing one or more query terms may form selection criteria for eliminating those correlations that have no relation to the query terms. As another example, user feedback such as by the selection of a specific class of node (e.g., a map, photo, etc.), a specific node object (e.g., friend “john doe” from a social network group), a specific attribute value (e.g., name=“john”), or specific links (e.g., string metrics, clustering, etc.) may be used as a basis for pruning correlations. Accordingly, for example, in the context of the exemplary embodiment of FIG. 8, the user could restrict the composite data graph by removing groups that do not include specific given words.

In another exemplary embodiment, the selection criteria could include context parameters. Context parameters may be used similarly to the usage of user feedback or query above to prune, reduce or focus a composite data graph. In this regard, for example, the criteria for correlation reduction may be based on context parameters such as time and/or location criteria. For example, correlations could be limited to time=“today” or location=“current location”. As a further example, the embodiment of FIG. 7 could have correlations removed based on a context related limitation regarding only considering photos taken within the last week.

In another exemplary embodiment, the selection criteria could include importance metrics. In this regard, for example, parameters of an algorithm (or algorithms) used to generate links (or attributes or nodes) may be adapted to be more restrictive in order to reduce the number of links. For example, if a minimum number of common words are needed to create a link between two groups, the minimum number of links may be set higher in order to reduce the number of linked groups. As another example, if a distance of the path between two nodes is considered with respect to link establishment, a limit may be imposed on the number of links allowed in order to prune correlations that have a large number of intermediate links. As yet another example, a number of minimum links for a given node may be set to a higher value so that only nodes with the minimum number of links are kept in the pruned data graph. Still other importance metrics could also be used for evaluating and reducing the number of nodes or correlations.

The visual mashup generator 82 may be configured to provide for a visualization of various pieces of information based on the correlations determined (and/or reduced) by the correlation miner 78 and/or the correlation reducer 80. As such, the visualization mashup generator 82 may determine which information to present and what arrangement to provide for the presentation of the information and communicate with the user interface 72 to generate the visualization. Visualization techniques that may be employed by the visual mashup generator 82 may include, for example, portlets, widgets, gadgets, pop-up windows, interface control consoles, web pages, links to webpages, and others that may be either static or interactive.

The visual mashup generator 82 may be configured to utilize correlations, for example, after pruning of such correlations by the correlation reducer 80, in order to generate a visual representation that is a mashup or composition of information associated with the objects or entities correlated. The mashup or composition of information may be generated in a manner that is symantically meaningful such as by including imagery that is, for example, literally or figuratively connected to the content or purpose of the data correlations used in the mashup. In some embodiments, imagery usable for making such a connection may be determined from the context associated with the data or information to be included in the mashup. As such, context information associated with the correlated entities may be determined in order to, for example, query a database for images related to keywords determined from the context. The context may be determined using existing information retrieval methods.

In an exemplary embodiment, in order to retrieve imagery to be used in a mashup, the visual mashup generator 82 may be configured to execute a semantically guided information retrieval process to automatically generate queries for retrieving images or other content from an image database or other source. If images are used, the images may be high quality photographs or illustrations. In some instances, the visual mashup generator 82 may simply provide a collection of images, media content, web pages, etc., that are related to the objects that have been correlated. However, in other cases, further content may also be added. In any case, the visual mashup generator 82 may be configured to provide for presentation of correlated information based on rules or guidelines for mashup generation that may be stored, for example, in the memory device 76. Moreover, the rules or guidelines could be different for various different contexts, content, event related stimuli, etc.

In cases where further content is added, for example, after the visual mashup generator 82 generates a query, the query may be submitted to an image database for retrieval. After retrieval of the relevant imagery, the visual mashup generator 82 may be further configured in some cases to apply stylizations to the retrieved images. For example, the visual mashup generator 82 may apply black and white, cartooning, conversion techniques, filtering techniques or other stylizations to further enhance visual effects associated with the mashup produced.

The retrieved relevant imagery may be combined to form composite visualization that may employ one or more visualization techniques such as those described above. In some embodiments, a predetermined or predefined mashup template may be utilized for creating mashups. In some cases, multiple predefined mashup templates may be stored and each one may be associated with a particular context, content type or event related stimulus. Modifications to templates may be made by an algorithm configured to make predefined modifications based on context, content types, expected audience, event related stimuli or the like. The final product may be a mashup or composite visualization that may be static or include certain interaction capabilities or behaviours. For example, the mashup may include or enable click-throughs, user query filters, mouse-overs, or the like. The mashup may also be augmented with other media interaction such as an audio or video clip played in conjunction with the mashup.

In an exemplary embodiment, the operation of the correlation miner 78, the correlation reducer 80 and/or the visual mashup generator 82 may be initiated in response to various different stimuli. For example, the correlation miner 78, the correlation reducer 80 and/or the visual mashup generator 82 may each operate at predetermined times, at predetermined intervals or in response to predetermined events. In this regard, for example, the pruning of data graphs may occur in response to location information detected at the position sensor 36 matching a given criteria, in response to a timer timing out or reaching a predetermined threshold, or in response to the addition of new content to a particular dataset. As another example, a mashup may be generated if the user logs into or enables a service associated with generating mashups. As such, any recognized intent, either inherent in an activity engaged in by the user and therefore implied, or express such as when the user specifically requests a mashup, may be utilized as a stimulus for initiating the operation of the correlation miner 78, the correlation reducer 80 and/or the visual mashup generator 82. As an example, if an SMS is received, the receipt of the SMS (perhaps based on rules stored in a user profile) may initiate the production of a mashup based on the SMS and data or information correlated therewith.

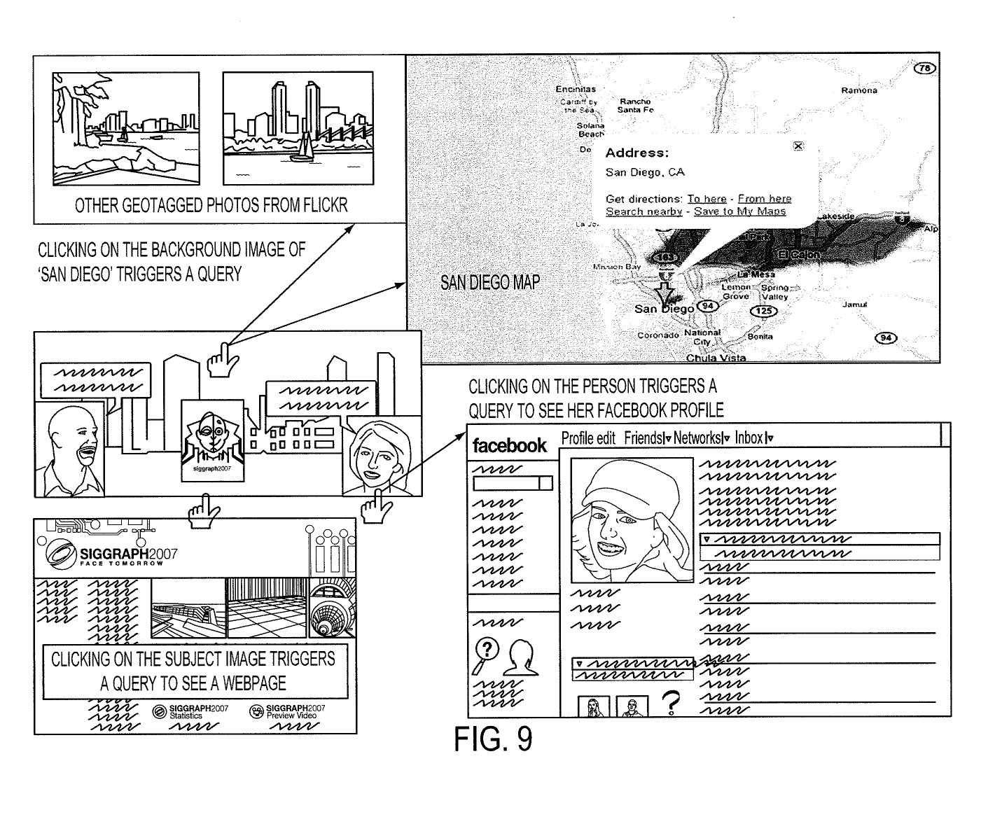

FIGS. 9-12 illustrate examples of several types of mashups that may be generated in accordance with exemplary embodiments of the present invention. In this regard, FIG. 9 shows a mashup used for personal information such as SMS data. The exemplary embodiment of FIG. 9 shows an interactive mashup where, for example, a Facebook page is included as a portion of the mashup and a map is included as another portion of the mashup. The Facebook page and/or the other website may merely be images or may include useable links corresponding to the links displayed. If the Facebook page and/or website are merely images, clicking on the Facebook page or website may activate a link to the corresponding page via the Internet. The mashup of FIG. 9 may be generated as a result of an SMS between two parties. The mashup generated may include, for example, a Facebook profile of one of the parties, a website associated with another of the parties, a map associated with a location of a proposed meeting site or address of one of the parties, pictures associated with the location and/or other related media or content as determined by the visual mashup generator 82 based on the correlation information provided thereto. As such, each interaction page or item shown in the mashup may be a mashup itself or an individual page.

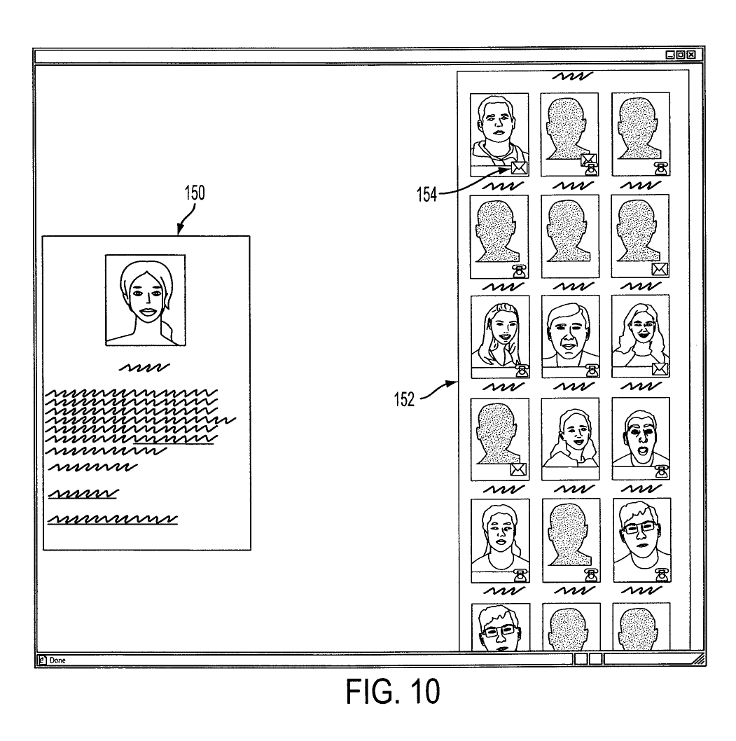

FIG. 10 illustrates an exemplary embodiment operating in the context of an enterprise phonebook application. In this regard, for example, an enterprise social phonebook may be presented on the basis of either a query or a default user (e.g., the individual user opening the application). As such, for example, a mashup of information related to the query user or default user may be provided at one portion of the display as indicated by element 150, while a mashup of related parties may be indicated in another portion of the display as indicated by element 152. The mashup illustrated by element 152 may include contacts by name, photo, both name and photo, avatar, caricature or other identifying mechanism in an order and with sizes that may be indicative or based on the nature of the relationship between each respective contact and the query user or default user. For example, most frequently contacted parties may be provided on top of the arrangement. Icons 154 associated with each contact may indicate the mechanism or mechanisms by which the query or default user may communicate with the corresponding contact. If a particular contact is selected, a mashup of the particular contacts personal information may be presented in replacement of the shown element 150 and a presentation of contacts associated with the particular contact may be shown in replacement of the shown element 152.

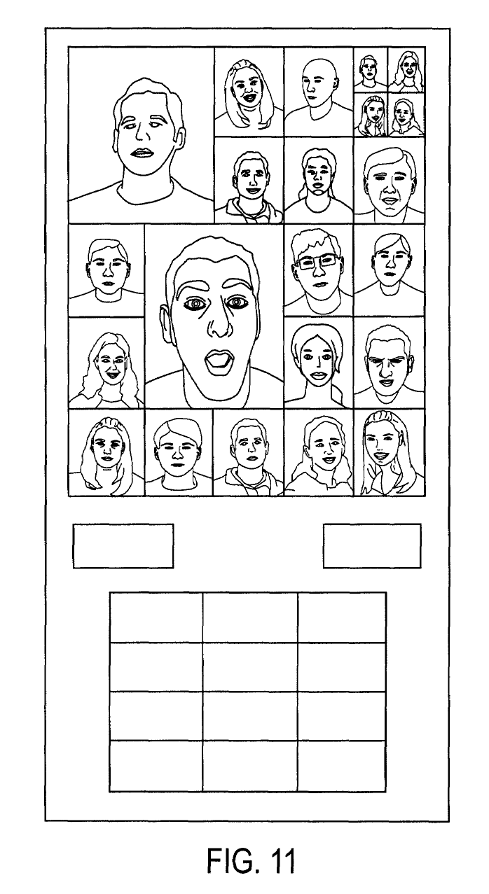

FIG. 11 shows another example of a mashup of images that may, for example, be associated with contacts that may be in communication via a mobile communication service. In this regard, the size and ordering of the images may indicate the degree to which the various contacts shown communicate with a query user. In an exemplary embodiment, selection of any particular contact may result in a presentation of a mashup corresponding to the particular contact selected.

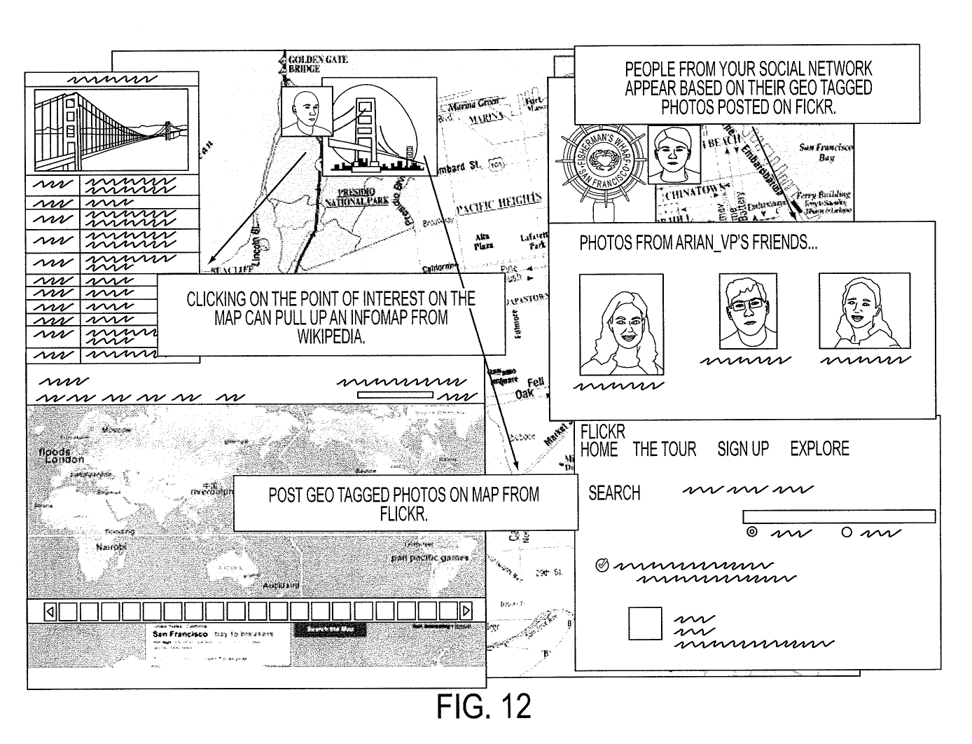

FIG. 12 shows another example of a mashup that combines personal information with map information as shown above in FIG. 9. In the exemplary embodiment of FIG. 12, clicking on various points on the map may initiate the presentation of geo-tagged photos corresponding to the selected location. Alternatively, information from an online information source may be retrieved regarding the selected location.

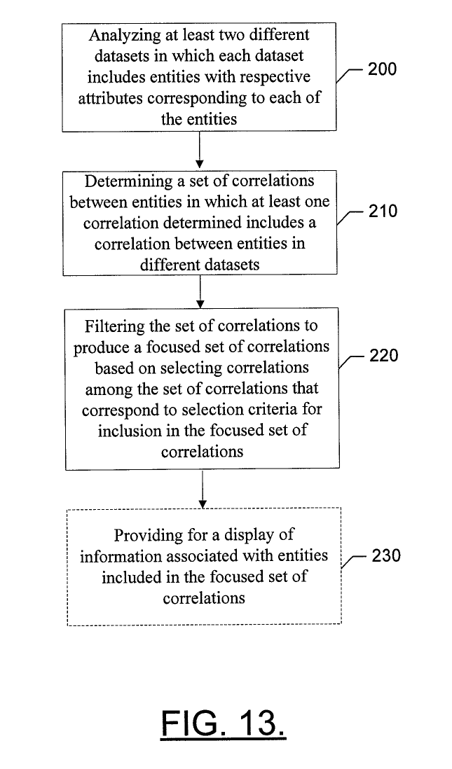

FIG. 13 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal or network device and executed by a processor in the mobile terminal or network device. As will be appreciated, any such computer program instructions may be loaded onto a computer or other programmable apparatus (i.e., hardware) to produce a machine, such that the instructions which execute on the computer (e.g., via a processor) or other programmable apparatus create means for implementing the functions specified in the flowcharts block(s) or step(s). These computer program instructions may also be stored in a computer-readable memory that can direct a computer (e.g., the processor or another computing device) or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for providing correlations of information from heterogeneous sources as illustrated, for example, in FIG. 7 may include analyzing at least two different datasets in which each dataset includes entities with respective attributes corresponding to each of the entities at operation 200. The method may further include determining a set of correlations between entities in which at least one correlation determined includes a correlation between entities in different datasets at operation 210. The set of correlations may be determined based at least in part on the respective attributes corresponding to each of the entities. The method may further include filtering or reducing the set of correlations to produce a focused set of correlations based on selecting correlations among the set of correlations that correspond to selection criteria for inclusion in the focused set of correlations at operation 220.

In some embodiments, the method may include further optional operations an example of which is shown in dashed lines in FIG. 13. For example, the method may further include providing for a display of information associated with entities included in the focused set of correlations at operation 230. In an exemplary embodiment, providing for the display of information may include generating a visual mashup of content associated with the entities included in the focused set of correlations. In such embodiments, generating the visual mashup may include providing a link to a webpage associated with an entity of the focused set of correlations or providing the webpage associated with the entity of the focused set of correlations. The link or the webpage may be provided along with at least additional information corresponding to another entity included in the focused set of correlations.

In an exemplary embodiment, analyzing the at least two different datasets may include analyzing datasets in which each dataset corresponds to objects or object classes associated with a particular and distinct service. In some cases, determining the set of correlations may include generating a composite data graph from separate data graphs corresponding to each respective different dataset in which the composite data graph includes links between entities within at least entities corresponding to the different datasets. In some cases, determining the set of correlations may further include determining at least one correlation between entities in the same dataset, and each correlation may be determined based on the respective attributes corresponding to each of the entities or based on relationships between the entities. In some embodiments, determining the set of correlations between the entities further includes determining an inferred correlation based on an analysis of content associated with at least one of the entities.

In an exemplary embodiment, reducing the set of correlations to produce the focused set of correlations may include selecting correlations in a composite data graph based on the selection criteria in which the selection criteria are used to reduce a number of the correlations in the focused set of correlations by establishing a predetermined distance function criteria value for inclusion in the focused set of correlations, pruning correlations from the set of correlations based on user input, or pruning correlations from the set of correlations based on context parameters or importance metrics.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
analyzing at least two different datasets in which each dataset includes entities with respective attributes corresponding to each of the entities;
determining a set of correlations between entities in which at least one correlation determined includes a correlation between entities in different datasets, the set of correlations being determined based at least in part on the respective attributes corresponding to each of the entities; and
filtering the set of correlations to produce a focused set of correlations based on selecting correlations among the set of correlations that correspond to selection criteria for inclusion in the focused set of correlations.

2. A method according to claim 1, further comprising providing for a display of information associated with entities included in the focused set of correlations.

3. A method according to claim 2, wherein providing for the display of information comprises generating a visual mashup of content associated with the entities included in the focused set of correlations.

4. A method according to claim 3, wherein generating the visual mashup comprises providing a link to a webpage associated with an entity of the focused set of correlations or providing the webpage associated with the entity of the focused set of correlations, the link or the webpage being provided along with at least additional information corresponding to another entity included in the focused set of correlations.

5. A method according to claim 1, wherein analyzing the at least two different datasets comprises analyzing datasets in which each dataset corresponds to objects or object classes associated with a particular and distinct service.

6. A method according to claim 1, wherein determining the set of correlations comprises generating a composite data graph from separate data graphs corresponding to each respective different dataset in which the composite data graph includes links between entities within at least entities corresponding to the different datasets.

7. A method according to claim 1, wherein filtering the set of correlations to produce the focused set of correlations comprises selecting correlations in a composite data graph based on the selection criteria in which the selection criteria are used to reduce a number of the correlations in the focused set of correlations by establishing a predetermined distance function criteria value for inclusion in the focused set of correlations.

8. A method according to claim 1, wherein filtering the set of correlations to produce the focused set of correlations comprises pruning correlations from the set of correlations based on user input.

9. A method according to claim 1, wherein filtering the set of correlations to produce the focused set of correlations comprises pruning correlations from the set of correlations based on context parameters or importance metrics.

10. A method according to claim 1, wherein determining the set of correlations between the entities further includes determining at least one correlation between entities in the same dataset, and wherein each correlation is determined based on the respective attributes corresponding to each of the entities or based on relationships between the entities.

11. A method according to claim 1, wherein determining the set of correlations between the entities further includes determining an inferred correlation based on an analysis of content associated with at least one of the entities.

12. An apparatus comprising a processor configured to:
analyze at least two different datasets in which each dataset includes entities with respective attributes corresponding to each of the entities;
determine a set of correlations between entities in which at least one correlation determined includes a correlation between entities in different datasets, the set of correlations being determined based at least in part on the respective attributes corresponding to each of the entities; and
filter the set of correlations to produce a focused set of correlations based on selecting correlations among the set of correlations that correspond to selection criteria for inclusion in the focused set of correlations.

13. An apparatus according to claim 12, wherein the processor is further configured to provide for a display of information associated with entities included in the focused set of correlations.

14. An apparatus according to claim 13, wherein the processor is configured to provide for the display of information by generating a visual mashup of content associated with the entities included in the focused set of correlations.

15. An apparatus according to claim 14, wherein the processor is configured to generate the visual mashup by providing a link to a webpage associated with an entity of the focused set of correlations or providing the webpage associated with the entity of the focused set of correlations, the link or the webpage being provided along with at least additional information corresponding to another entity included in the focused set of correlations.

16. An apparatus according to claim 12, wherein the processor is configured to analyze the at least two different datasets by analyzing datasets in which each dataset corresponds to objects or object classes associated with a particular and distinct service.

17. An apparatus according to claim 12, wherein the processor is configured to determine the set of correlations by generating a composite data graph from separate data graphs corresponding to each respective different dataset in which the composite data graph includes links between entities within at least entities corresponding to the different datasets.

18. An apparatus according to claim 12, wherein the processor is configured to filter the set of correlations to produce the focused set of correlations by selecting correlations in a composite data graph based on the selection criteria in which the selection criteria are used to reduce a number of the correlations in the focused set of correlations by establishing a predetermined distance function criteria value for inclusion in the focused set of correlations.

19. An apparatus according to claim 12, wherein the processor is configured to filter the set of correlations to produce the focused set of correlations by pruning correlations from the set of correlations based on user input.

20. An apparatus according to claim 12, wherein the processor is configured to filter the set of correlations to produce the focused set of correlations by pruning correlations from the set of correlations based on context parameters or importance metrics.

21. An apparatus according to claim 12, wherein the processor is further configured to determine at least one correlation between entities in the same dataset, and wherein each correlation is determined based on the respective attributes corresponding to each of the entities or based on relationships between the entities.

22. An apparatus according to claim 12, wherein the processor is configured to determine the set of correlations between the entities by determining an inferred correlation based on an analysis of content associated with at least one of the entities.

23. A computer program product comprising at least one computer-readable storage medium having computer-executable program code portions stored therein, the computer-executable program code portions comprising:
a first program code portion for analyzing at least two different datasets in which each dataset includes entities with respective attributes corresponding to each of the entities;
a second program code portion for determining a set of correlations between entities in which at least one correlation determined includes a correlation between entities in different datasets, the set of correlations being determined based at least in part on the respective attributes corresponding to each of the entities; and
a third program code portion for filtering the set of correlations to produce a focused set of correlations based on selecting correlations among the set of correlations that correspond to selection criteria for inclusion in the focused set of correlations.

24. A computer program product according to claim 23, further comprising a fourth program code portion for providing for a display of information associated with entities included in the focused set of correlations.

25. A computer program product according to claim 24, wherein the fourth program code portion includes instructions for generating a visual mashup of content associated with the entities included in the focused set of correlations.

26. A computer program product according to claim 25, wherein the fourth program code portion includes instructions for providing a link to a webpage associated with an entity of the focused set of correlations or providing the webpage associated with the entity of the focused set of correlations, the link or the webpage being provided along with at least additional information corresponding to another entity included in the focused set of correlations.

27. A computer program product according to claim 23, wherein the first program code portion includes instructions for analyzing datasets in which each dataset corresponds to objects or object classes associated with a particular and distinct service.

28. A computer program product according to claim 23, wherein the second program code portion includes instructions for generating a composite data graph from separate data graphs corresponding to each respective different dataset in which the composite data graph includes links between entities within at least entities corresponding to the different datasets.

29. A computer program product according to claim 23, wherein the third program code portion includes instructions for selecting correlations in a composite data graph based on the selection criteria in which the selection criteria are used to reduce a number of the correlations in the focused set of correlations by establishing a predetermined distance function criteria value for inclusion in the focused set of correlations.

30. A computer program product according to claim 23, wherein the third program code portion includes instructions for pruning correlations from the set of correlations based on user input.

31. A computer program product according to claim 23, wherein the third program code portion includes instructions for pruning correlations from the set of correlations based on context parameters or importance metrics.

32. A computer program product according to claim 23, wherein the second program code portion includes instructions for determining at least one correlation between entities in the same dataset, and wherein each correlation is determined based on the respective attributes corresponding to each of the entities or based on relationships between the entities.

33. A computer program product according to claim 23, wherein the second program code portion includes instructions for determining an inferred correlation based on an analysis of content associated with at least one of the entities.

34. An apparatus comprising:
means for analyzing at least two different datasets in which each dataset includes entities with respective attributes corresponding to each of the entities;
means for determining a set of correlations between entities in which at least one correlation determined includes a correlation between entities in different datasets, the set of correlations being determined based at least in part on the respective attributes corresponding to each of the entities; and
means for filtering the set of correlations to produce a focused set of correlations based on selecting correlations among the set of correlations that correspond to selection criteria for inclusion in the focused set of correlations.
